(19) United States
(12) Patent Application Publication
(10) Pub. No.: US 2026/0211777 A1
(43) Pub. Date: Jul. 23, 2026

(54) DATA MANAGEMENT SERVICES USING DYNAMIC AND STATIC CLOUD COMPUTING RESOURCES

(71) Applicant: Rubrik, Inc., Palo Alto, CA (US)

(72) Inventors: Prasenjit Sarkar, Los Gatos, CA (US); Jun Xu, Kirkland, WA (US); Vaiapuri Ramasubramaniam, Bengaluru (IN); Vinita Sharma, Bengaluru (IN)

(21) Appl. No.: 19/033,389

(22) Filed: Jan. 21, 2025

(51) Int. Cl. G06F 11/1446

(52) U.S. Cl. CPC G06F 11/1461; G06F 11/1451; G06F 11/1464

(57) ABSTRACT

Methods, systems, and devices for data management are described. A data management system (DMS) may provide backup and recovery services for customer systems. The DMS may be hosted at a cloud environment. A DMS may perform some tasks associated with backup and recovery services using a set of static cloud computing resources and the DMS may perform some tasks associated with the backup and recovery services using a set of dynamic cloud computing resources. The division of resources may be selected to minimize cloud computing costs. For example, tasks that involve a less variable computing resource load, such as scheduling services and backup chain management, may be performed using the static cloud computing resources, and tasks that involve more dynamic loads may be performed using dynamic cloud computing resources.

### FIELD OF TECHNOLOGY

The present disclosure relates generally to data management, including techniques for data management services using dynamic and static cloud computing resources.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports data management services using dynamic and static cloud computing resources in accordance with aspects of the present disclosure.

FIG. 2 shows an example of a computing environment that supports data management services using dynamic and static cloud computing resources in accordance with aspects of the present disclosure.

FIG. 3 shows an example of a process flow that supports data management services using dynamic and static cloud computing resources in accordance with aspects of the present disclosure.

FIG. 4 shows a block diagram of an apparatus that supports data management services using dynamic and static cloud computing resources in accordance with aspects of the present disclosure.

FIG. 5 shows a block diagram of a DMS Manager that supports data management services using dynamic and static cloud computing resources in accordance with aspects of the present disclosure.

FIG. 6 shows a diagram of a system including a device that supports data management services using dynamic and static cloud computing resources in accordance with aspects of the present disclosure.

FIGS. 7 through 10 show flowcharts illustrating methods that support data management services using dynamic and static cloud computing resources in accordance with aspects of the present disclosure.

### DETAILED DESCRIPTION

A data management system (DMS) may provide backup and recovery services for customer systems. For example, the DMS may store snapshot data and associated metadata for one or more computing objects of a customer in a cloud storage environment. The DMS may be hosted at a cloud environment. For example, the DMS may perform tasks such as: scheduling backup tasks; obtaining the backup data from the customer computing objects; compressing the backup data; storing the backup data in the cloud storage environment; maintaining and/or updating the linkages between snapshots; and/or consolidating expired snapshots. Such tasks may be performed by the DMS using a set of static cloud computing resources. A cloud computing resource may be, for example, a virtual machine and the associated central processing unit (CPU) and memory. Static cloud computing resources refer to cloud computing resources that are reserved in advance from a cloud computing provider. Use of static cloud computing resources may facilitate software construction for tasks, as the particular resources (e.g., the network addresses of the particular resources) used for particular tasks may be scheduled and/or hard coded.

Use of static cloud computing resources, however, may involve reserving a quantity of computing resources to support a maximum computing load of the DMS. In such cases, a customer may pay for more cloud computing resources than may be typically used (e.g., at non-peak load times). In some cases, customers of the DMS may shut down some tasks or features of the DMS when not in use in order to save costs on static cloud computing resources. Turning tasks or features of the DMS on or off, however, may involve additional latency, additional manual tasks, and/or potential missed tasks. An alternative to use of static cloud computing resources may be to dynamically acquire cloud computing resources based on the dynamic or instantaneous computing load of the DMS. Such cloud computing resources that can be dynamically acquired on-demand from a cloud computing provider may be referred to as dynamic cloud computing resources. Cloud providers, however, may charge more for dynamic cloud computing resources than for static cloud computing resources. Accordingly, use of all dynamic cloud computing resources for data management services may increase costs for customers of the DMS.

Aspects of this disclosure involve a hybrid approach in which some tasks of the DMS are performed using a set of static cloud computing resources and some tasks of the DMS are performed using a set of dynamic cloud computing resources. For example, a first service of the DMS may be hosted at a set of static cloud computing resources, and a second service of the DMS may be hosted at a set of dynamic cloud computing resources. The division of resources may be selected to minimize cloud computing costs. For example, tasks that involve a more consistent (e.g., less variable) computing resource load, such as scheduling services and backup chain management, may be performed using the static cloud computing resources (e.g., performed by the service(s) hosted on the static cloud computing resources), and tasks that involve more dynamic loads (e.g., more volatile loads or loads that fluctuate over time), such as backup ingestion and compression, may be performed using dynamic cloud computing resources (e.g., performed by the service(s) hosted on the dynamic cloud computing resources). For example, in the context of backup management for a customer, a first backup service hosted at a set of static cloud computing resources may manage the scheduling of snapshots of a computing object associated with the customer. The first backup service may send a command to a second backup service hosted at a set of dynamic cloud computing resources to perform tasks for a backup operation for the computing object. The second backup service may perform backup tasks to obtain the snapshot, such as backup ingestion, compression, and storage. The quantity of resources used by the second backup service may dynamically change based on the computing load of the backup operations. After acquisition and storage of the snapshot, the first backup service may perform additional backup tasks such as updating the snapshot chain for the computing object.

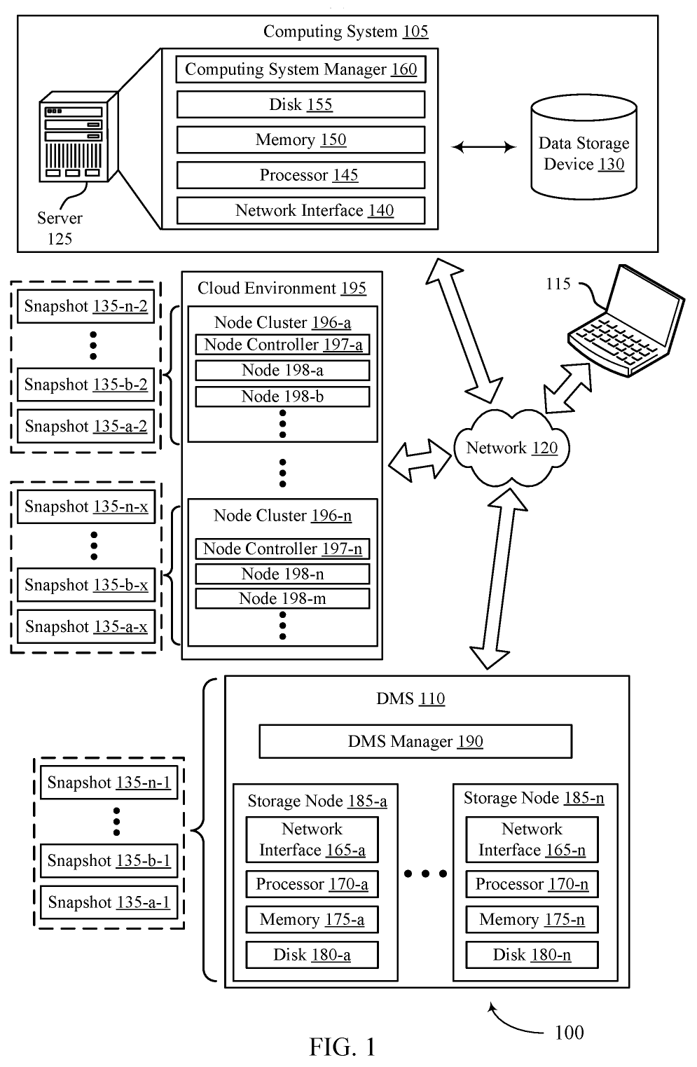

FIG. 1 illustrates an example of a computing environment 100 that supports data management services using dynamic and static cloud computing resources in accordance with aspects of the present disclosure. The computing environment 100 may include a computing system 105, a DMS 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructureas-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant’s data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

In some aspects, the DMS 110 may be hosted at a cloud environment (e.g., which may be the cloud environment 195 or a different cloud environment from the cloud environment 195). For example, the DMS 110 may perform tasks such as: scheduling backup tasks; obtaining the backup data from the customer computing objects; compressing the backup data; storing the backup data in the cloud storage environment; maintaining and/or updating the linkages between snapshots; and/or consolidating expired snapshots. Such tasks may be performed using cloud computing resources.

In some aspects, some tasks of the DMS 110 may be performed using a set of static cloud computing resources and some tasks of the DMS 110 may be performed using a set of dynamic cloud computing resources. For example, a first service of the DMS 110 may be hosted at the set of static cloud computing resources, and a second service of the DMS 110 may be hosted at the set of dynamic cloud computing resources. The set of dynamic cloud computing resources and the set of static cloud computing resources may be provided by the same cloud computing provider or different cloud computing providers (e.g., AWS, Azure, Google Cloud Platform, among others). The division of resources may be selected to minimize cloud computing costs. For example, tasks that involve a more consistent computing resource load, such as scheduling services and backup chain management, may be performed using the static cloud computing resources (e.g., performed by the service(s) hosted on the static cloud computing resources), and tasks that involve more dynamic loads (e.g., more volatile loads or loads that fluctuate over time), such as backup ingestion and compression, may be performed using dynamic cloud computing resources (e.g., performed by the service(s) hosted on the dynamic cloud computing resources).

In some aspects, an operator of the DMS 110, or a customer of the DMS 110, may analyze CPU, memory, and/or I/O usage associated with different tasks of the DMS 110 over time. Based on the analysis, the tasks of the DMS 110 may be organized into tasks that are associated with more dynamic/variable loads (e.g., and may be more efficiently scheduled to be performed by dynamic cloud computing resources) and tasks that are associated with more consistent loads (e.g., and may be more efficiently scheduled to be performed by static cloud computing resources). The services of the DMS 110 may be deployed across static cloud computing resources and dynamic cloud computing resources based on the analysis. For example, the DMS 110 may maintain a set of static cloud computing resources (e.g., static elements) and may allocate dynamic cloud computing resources (e.g., dynamic elements) depending on the incoming backup and/or recovery activity.

For example, the analysis phase may involve measurement of the CPU, memory, I/O, and related metrics in the face of a variety of application workloads. Such application workloads may include data management operations for computing systems 105 such as virtual machines or databases (across the computing systems 105 managed by the DMS 110 for a customer. The data management operations may include backup operations (e.g., capturing snapshots 135), archival (e.g., storing snapshots in the storage environments such as the storage nodes 185 or node clusters 196), replication, compression (e.g., prior to storage), consolidation, and recovery. Different operations may be associated with multiple tasks. Different customers of the DMS 110 may have different computing systems (in type, quantity, and/or scale), which may lead to variety in the analysis of the workloads between different customers of the DMS 110. Additionally, or alternatively, the expected backup frequency (e.g., per backed up computing object) may lead to variety in which tasks are associated with mode dynamic or static loads. For example, higher frequency scheduled backups (e.g., every hour) may involve more static use of resources for tasks associated with the backup operations, while lower frequency scheduled backups (e.g., every week) may involve more dynamic use of resources for tasks associated with the backup operations. As another example, different retention times may lead to variety in which tasks are associated with mode dynamic or static loads. For example, shorter retention times may involve more frequent consolidation operations of snapshots 135 (e.g., and thus a more static use of resources), while longer retention times may involve less frequent consolidation operations of snapshots 135 (e.g., and thus more dynamic use of resources).

As described herein, based on the analysis, per customer of the DMS 110, or across the DMS 110, tasks may be partitioned into dynamic tasks and static tasks. Static tasks may be associated with more consistent usage of cloud computing resources over time (e.g., independent of incoming application activity, while dynamic tasks may be associated with more variable or fluctuating usage of cloud computing resources over time (e.g., which may scale as application activity increases or decreases). For example, the size of a particular backup (e.g., how much data there is to capture and compress in a particular snapshot) may vary from snapshot 135 to snapshot 135. For example, for incremental snapshots, one snapshot may have a small amount of data due to few changes occurring since the prior snapshot 135, while a subsequent snapshot may have a large amount of data due to many changes since the prior snapshot. Thus, snapshot ingestion and associated tasks (e.g., compression and storage) may be associated with dynamic tasks. Partitioning of tasks between services of the DMS 110 hosted at a set of static cloud computing resources and a set of dynamic resources may involve hosting the services at different network addresses. Accordingly, secure and scalable communication primitives may be established between the static and dynamically hosted services. For example, a scheduling service of the DMS 110 and/or the DMS manager 190 may be hosted at the set of static cloud computing resources and may manage communications between the static and dynamically hosted services.

As described herein, the services and tasks of the DMS 110 may be deployed across static cloud computing resources and dynamic cloud computing resources based on the partitioning of tasks in to static and dynamic tasks. For example, in the context of backup management for a customer, a first backup service hosted at a set of static cloud computing resources may manage the scheduling of snapshots of a computing object associated with the customer. The first backup service may send a command to a second backup service hosted at a set of dynamic cloud computing resources to perform tasks for a backup operation for the computing object. The second backup service may perform backup tasks to obtain the snapshot, such as backup ingestion and compression. The quantity of resources used by the second backup service may dynamically change based on the computing load of the backup operations. After acquisition and storage of the snapshot 135, the first backup service may perform additional backup tasks such as updating the snapshot chain for the computing object and consolidating and deleting expired snapshots.

Tasks may be scheduled in a cost-conscious manner based on the partitioning of static and dynamic tasks. For example, if the set of static cloud computing resources are able to complete a daily periodic task within 8 hours-leaving, 16 hours of unused static resources, the quantity of static cloud computing resources dedicated to the task may be scaled down to complete the task in 24 hours to fully utilize the static cloud computing resources (e.g., and therefore less costs as fewer static cloud computing resources may be reserved). Tasks may be similarly be scheduled for the dynamic computing resources. Costs of resources from cloud providers may not be linear, and thus the quantity of resources may be selected based on a cost curve.

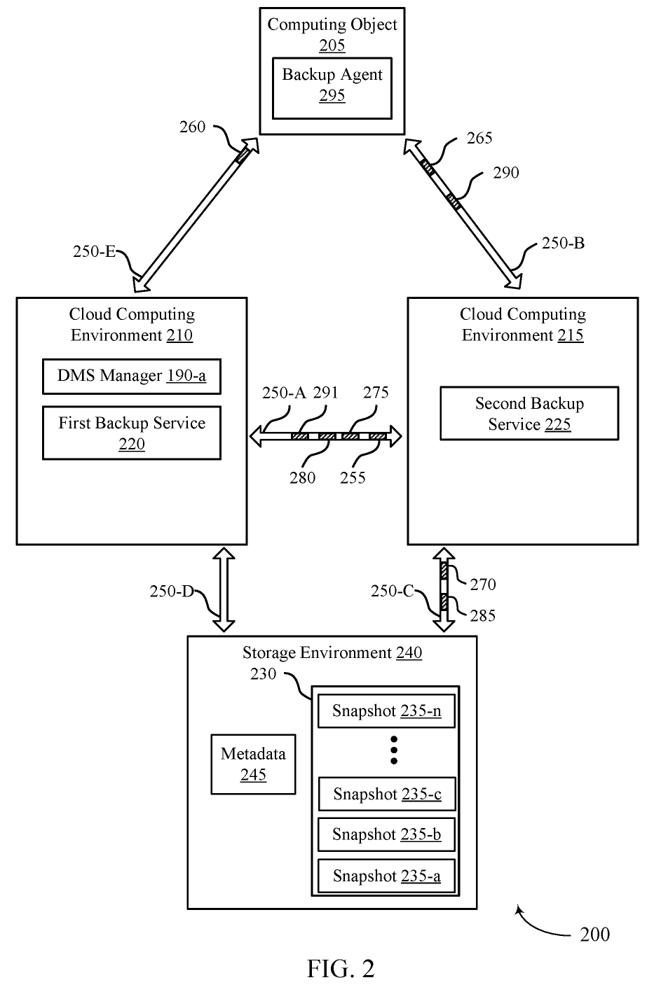

FIG. 2 shows an example of a computing environment 200 that supports data management services using dynamic and static cloud computing resources in accordance with aspects of the present disclosure. The computing environment 200 may implement or may be implemented by aspects of the computing environment 100.

A DMS 110 may manage backup and recovery services for a computing object 205 (e.g., a computing system 105 as described herein). The DMS 110 may include a DMS manager 190-a. The DMS 110 may include a first backup service 220 hosted at a first cloud computing environment 210 (e.g., hosted at a first set of cloud computing resources) and a second backup service 225 hosted at a second cloud computing environment 215 (e.g., hosted at a second set of cloud computing resources). For example, the first cloud computing environment 210 may include static cloud computing resources (e.g., the first backup service 220 and/or the DMS manager 190-a may be hosted on static cloud computing resources), and the second cloud computing environment 215 may include dynamic cloud computing resources (e.g., the second backup service 225 may be hosted on dynamic cloud computing resources). Although shown as two separate cloud computing environments, the cloud computing resources of the first cloud computing environment 210 and the second cloud computing environment 215 may be provided by the same cloud computing provider. In some examples, the cloud computing resources of the first cloud computing environment 210 and the second cloud computing environment 215 may be provided by different cloud computing providers. The quantity of cloud computing resources of the first cloud computing environment 210 used by the first backup service may be fixed or static. The quantity of cloud computing resources of the second cloud computing environment 215 may be dynamically adjusted based on the load of the second backup service 225. Although shown as separate entities, in some examples, the DMS manager 190-a and the first backup service 220 may be a same entity (e.g., hosted on the same set of computing resources and/or performing the same tasks).

The first backup service 220 and the second backup service 225 may perform tasks to complete backup and recovery operations for the computing object 205. For example, the DMS 110 that includes the first backup service 220 and the second backup service 225 may obtain and store snapshots 235 of the computing object 205 in a storage environment 240. The storage environment 240 may be one or more storage nodes 185 or one or more node clusters 196 as described herein, or any other network connected storage environment. In some examples, the storage environment 240 may be a same cloud environment or may be provided by a same cloud provider as either the first cloud computing environment 210 or the second cloud computing environment 215. The snapshots 235 may be stored as a snapshot chain 230 (e.g., a chain of one or more full and incremental snapshots). For example, a first snapshot 235-a may be a base or full snapshot of the computing object, and the snapshot 235-b, the snapshot 235-c, . . . ., and the snapshot 235-n, may be incremental snapshots. Metadata 245 may indicate the storage locations (e.g., the physical storage locations of particular data blocks) of the snapshots 235 and/or the linkages between the snapshots 235 (e.g., pointers indicating the order of the snapshot chain 230).

As described herein, tasks for data backup and recovery services of the DMS 110 may be partitioned between first backup service 220 and the second backup service 225 based on whether the tasks are associated with more consistent computing resource loads or variable/fluctuating computing resource loads. For example, tasks associated with more consistent computing resource loads may be performed by the first backup service 220 hosted on the set of static cloud computing resources, and tasks associated with variable/fluctuating computing resource loads may be performed by the second backup service 225. The first backup service 220 may communicate with the second backup service 225 via a network connection 250-a, which may be any communication channel or method over a network 120 as described herein. For example, communication over the network connection 250-a may be based on network addresses of the first backup service 220 and the second backup service 225 (e.g., the first backup service 220 may store and use the network address of the second backup service 225, and/or the second backup service 225 may store and use the network address of the first backup service). The second backup service 225 may communicate with the computing object 205 via a network connection 250-b (e.g., a connection via the network 120 as described herein). Similarly, the second backup service 225 may communicate with the storage environment 240 via a network connection 250-c, the first backup service 220 may communicate with the storage environment 240 via a network connection 250-d, and/or the first backup service 220 may communicate with the computing object 205 via a network connection 250-e.

In some examples, the first backup service 220 may manage and/or perform scheduling tasks for backup and recovery services for the computing object 205. For example, to perform a backup operation for the computing object (e.g., to capture and store a snapshot 235 of the computing object 205), the first backup service 220 may send a command 255 to perform one or more first tasks associated with the backup operation for the computing object 205. For example, the DMS 110 may be scheduled to perform periodic backup operations for the computing object (e.g., in accordance with a service level agreement (SLA), which may trigger the first backup service 220 to send the command 255. As another example, an administrative user of the DMS 110 may send a request to the DMS (e.g., received by the DMS manager 190-a and/or the first backup service 220) to perform a backup operation for the computing object 205 at a particular time via a computing device 115 as described herein (e.g., such a command may be input via a user interface of the computing device 115). Based on the command 255, the second backup service 225 may perform one or more tasks associated with the backup operation. For example, the second backup service 225 may obtain backup information 265 of the computing object 205 (e.g., the second backup service 225 may ingest the backup information 265 for the computing object 205), may process the backup information 265, and may send the processed backup information 270 to the storage environment 240 (e.g., which may be stored as a snapshot 235). For example, processing tasks for the backup information 265 may involve determination of the differences with respect to a prior snapshot (e.g., to generate an incremental snapshot), compression of the backup information 265, and/or encryption of the backup information 265.

In some examples, the first backup service 220 may send a command 260 to a backup agent 295 at the computing object 205 to initiate the backup operation (e.g., in addition to or instead of the command 255). For example, in response to reception of the command, the backup agent 295 may send the backup information 265 to the second backup service 225. For example, the backup agent 295 may be informed of the network address of the second backup service 225. In some examples, the backup agent 295 may perform one or more of the second tasks, such as identification of the difference information between the current backup information and prior backup information (e.g., such that the backup information 265 may include delta information), compression of the backup information 265 (e.g., to reduce the amount of transmitted information), and/or encryption of the backup information 265.

The second backup service 225 may send an indication 275 of completion of the one or more tasks associated with the backup operation to the first backup service 220. For example, the indication 275 may indicate a storage location (e.g., address in the storage environment 240) of the snapshot 235-n. Based on the indication 275, the first backup service 220 may perform one or more second tasks associated with the backup operation. For example, the first backup service 220 may update the metadata 245 associated with the snapshot chain 230 for the computing object 205 based on the storage location of the snapshot 235 of the computing object associated with the backup operation, where the indication of completion of the one or more first tasks indicates the storage location of a snapshot 235-n of the computing object 205. In some examples, the one or more tasks may include updating pointers in the metadata 245 or the snapshot 235-n to one or more prior snapshots 235 (e.g., where the snapshot 235-n is an incremental snapshot).

In some examples, the DMS 110 may perform a restore operation for the computing object 205. For example, an administrative user of the DMS 110 may request the computing object be restored to a particular point in time version (e.g., corresponding to one of the snapshots 235) via a computing device 115 as described herein. The request may be received by the DMS manager 190-a or the first backup service 220. As another example, a restore operation to a most recent restore point (e.g., the most recent snapshot 235) may by triggered by a detected failure at the computing object 205. For example, the backup agent 295 and/or the first backup service 220 may monitor the computing object 205 for hardware or other types of failure that may trigger a restore operation. In response to receiving the request for a restore operation or determining a triggering condition for a restore operation, the first backup service 220 may send a command 280 to the second backup service 225 to perform one or more tasks associated with the restore operation. For example, the command 280 may indicate the snapshot 235 to use (e.g., the target restore time), the computing object 205, and/or the storage locations of the target snapshot 235. For example, the command 280 may indicate to use the snapshot 235-n to perform the restore operation for the computing object 205.

Based on the command 280, the second backup service 225 may perform the one or more tasks associated with the restore operation. For example, the second backup service 225 may retrieve the snapshot 235-n associated with the target restore time as restore information 285. For example, the second backup service 225 may retrieve the data blocks of the snapshot 235-n and the other data blocks in the snapshot chain 230 on which the snapshot 235-n depends in accordance with the metadata 245 (e.g., in the case that the snapshot 235-n is an incremental snapshot). The second backup service 225 may perform one or more additional processing tasks, such as decryption and/or decompression of the restore information 285. The second backup service 225 may send the restore information 290 (e.g., the processed restore information) to the computing object 205 to restore the computing object 205 to the target restore version. The backup agent 295 may assist with the restore operation (e.g., may perform one or more tasks associated with the restore operation). The second backup service 225 may send an indication 291 of completion of the one or more tasks associated with the restore operation (e.g., of completion of the restore operation). Based on the indication 291, the first backup service 220 may perform one or more additional tasks associated with the restore operation, such as updating the metadata 245 of the snapshot chain 230.

In some examples, the DMS 110 may perform consolidation of snapshots 235. For example, the first backup service 220 may track the expiration of snapshots. For example, an SLA may indicate to retain snapshots for a period of time (e.g., 6 months, 1 year, etc.). When a particular snapshot expires, the first backup service 220 and/or the second backup service may perform tasks associated with consolidating the expired snapshot. For example, if the first backup service 220 performs the consolidation operations, the first backup service 220 may schedule the consolidation operation for a time when the static resources of the first backup service 220 are available (e.g., not being used for other scheduled tasks such as backup operation tasks). For example, if the snapshot 235-b expires, the first backup service 220 may combine the data of the snapshot 235-b with the data of the snapshot 235-c (e.g., which is unexpired) to generate an unexpired snapshot corresponding to the point in time of snapshot 235-c. The first backup service 220 may update the metadata 245 to indicate the consolidation of the snapshot 235-b and the snapshot 235-c. In some examples, one or more of the consolidation tasks may be performed by the second backup service 225. For example, the first backup service 220 may send a command to second backup service 225 to perform one or more tasks associated with the consolidation operation (e.g., the command may indicate which snapshot 235 expired), and the second backup service 225 may perform the one or more consolidation tasks and indicate to the first backup service 220 completion of the one or more consolidation tasks. For example, the second backup service 225 may perform more dynamic tasks such as the consolidation of the snapshot 235-b with the snapshot 235-c. Based on the indication of completion of the one or more consolidation tasks, the first backup service 220 may perform one or more additional consolidation tasks (e.g., updating the metadata 245 of the snapshot chain 230 based on the consolidation of the snapshot 235-b with the snapshot 235-c).

In some examples, the DMS 110 (e.g., the first backup service 220 and the second backup service 225) may manage backup and restore operations for multiple computing objects (e.g., in addition to the computing object 205). For example, the DMS 110 may manage backup and restore operations for multiple computing objects of the one or more customers. For example, the first backup service 220 and the second backup service 225 may coordinate to obtain and store snapshots for the multiple computing objects in the storage environment 240 as described herein, and may use the snapshots for restore operations for the multiple computing objects as described herein.

As described herein, the quantity of cloud computing resources of the first backup service 220 may be fixed, and the quantity of cloud computing resources of the second backup service 225 may be dynamic or variable depending on the load. For example, the second backup service 225 may acquire more cloud computing resources from the second cloud computing environment 215 when performing tasks such as the one or more tasks associated with the backup operations, the restore operations, and/or the consolidation operations. The first backup service 220 may schedule backup, restore, and/or consolidation operations to reduce peak loads on the first backup service 220 (e.g., to maintain consistent usage of the static cloud computing resources) and/or the second backup service 225 (e.g., to reduce variability of the quantity of cloud computing resources of the second backup service 225).

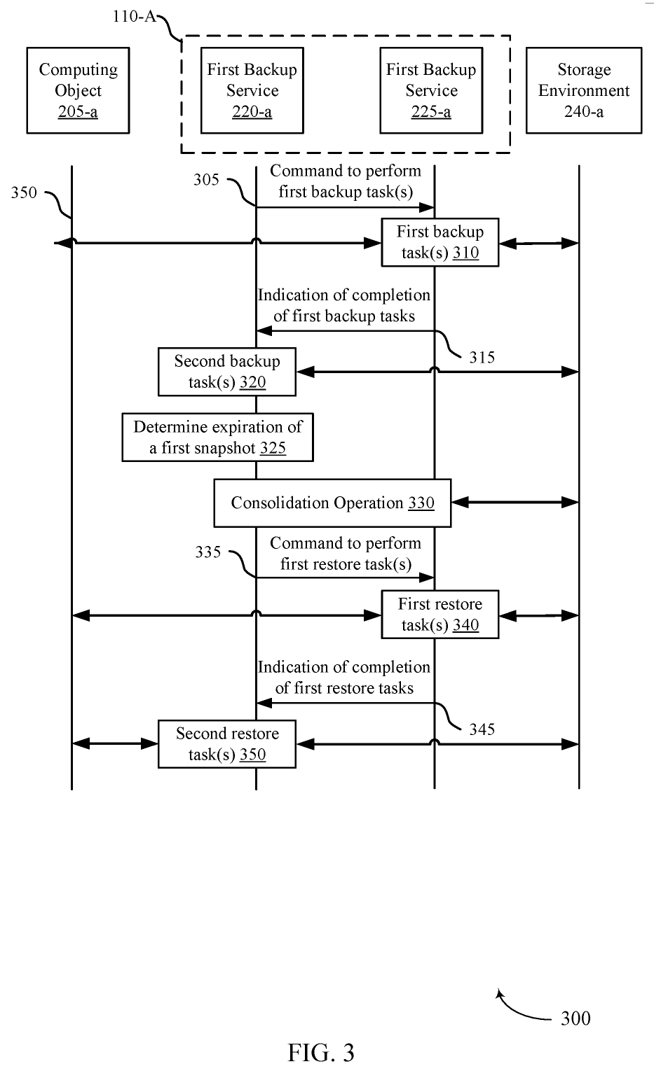

FIG. 3 shows an example of a process flow 300 that supports data management services using dynamic and static cloud computing resources in accordance with aspects of the present disclosure. The process flow 300 may implement or be implemented by aspects of the computing environment 100 or the computing environment 200. For example, the process flow 300 includes a DMS 110-a, which may be an example of a DMS 110 as described herein. The DMS 110-a may include a first backup service 220-a, which may be an example of a first backup service 220 as described herein, and a second backup service 225-a, which may be an example of a second backup service 225 as described herein. The process flow 300 may include a storage environment 240-a, which may be an example of a storage environment 240 as described herein. The process flow 300 may include a computing object 205-a, which may be an example of a computing object as described herein. In the following description of the process flow 300, the operations between the first backup service 220-a, the second backup service 225-a, the computing object 205-a, and the storage environment 240-a may be performed in a different order than the example order shown. Some operations may also be omitted from the process flow 300, and other operations may be added to the process flow 300.

At 305, the first backup service 220-a may send a command to the second backup service 225-a to perform one or more first tasks associated with a backup operation for the computing object 205-a. As described herein, the first backup service 220-a may be hosted at a first set of cloud computing resources, and a first quantity of computing resources of the first set of cloud computing resources may be static. The second backup service 225-a may be hosted at a second set of cloud computing resources, and a second quantity of computing resources of the second set of cloud computing resources may be dynamic based on the one or more first tasks (e.g., based on a load on the second backup service 225-a, including the load of the one or more first tasks). In some examples, the first backup service 220-a may obtain, from a user interface associated with the DMS 110-a, a request to perform the backup operation for the computing object, and the backup operation (e.g., sending the command at 305) may be on the request. In some examples, the DMS 110-a may be scheduled to perform periodic backup operations for the computing object 205-a, and the first backup service 220-a may send the command at 305 based on the periodic backup schedule. In some examples, the first backup service 220-a may obtain an indication of a second network address associated with the second backup service 225-a, and sending the command at 305 may be based on the second network address. In some examples, the command may be indicative of a first network address associated with the first backup service 220-a.

At 310, the second backup service 225-a may perform the one or more first tasks. For example, the one or more first tasks may include ingestion of backup information associated with the computing object 205-a, compression of the backup information, encryption of the backup information, storage of the backup information at the storage environment 240-a, or a combination thereof. In some examples, the first backup service 220-a may schedule (e.g., may indicate in the command at 305), the one or more first tasks based on a load on the second set of cloud computing resources.

At 315, the second backup service 225-a may send, and the first backup service 220-a may receive, an indication of completion of the one or more first tasks.

At 320, the first backup service 220-a may perform, based on the indication at 315, one or more second tasks associated with the backup operation. For example, the one or more second tasks may include updating metadata associated with a snapshot chain for the computing object based on a storage location of a snapshot of the computing object associated with the backup operation, where the indication of completion of the one or more first tasks at 315 indicates the storage location of a snapshot of the computing object 205-a in the storage environment 240-a. In some examples, where the snapshot is an incremental snapshot, updating the snapshot chain may involve updating pointers to one or more prior snapshots of the computing object 205-a. In some examples, the first backup service 220-a may schedule the one or more second tasks based on a load on the first set of cloud computing resources. For example, the first backup service 220-a may schedule tasks for the first backup service 220-a to maintain a consistent load on the static computing resources of the first backup service 220-a (e.g., to avoid under or over provisioning of static computing resources).

In some examples, as described herein, the second quantity of computing resources of the second set of cloud computing resources may be dynamically increased based on an increase in an instantaneous load at the second backup service 225-a. In some examples, as described herein, the second quantity of computing resources of the second set of cloud computing resources may be dynamically decreased based on a decrease in the instantaneous load at the second backup service 225-a.

In some examples, at 325, the first backup service 220-a may determine an expiration of a first snapshot of the computing object 205-a. At 330, the first backup service 220-a and/or the second backup service 225-a may perform, based at least in part on the determined expiration, a consolidation operation of the first snapshot with a second snapshot of the computing object 205-a. For example, the first backup service 220-a and/or the second backup service 225-a may perform one or more tasks associated with the consolidation operation (e.g., combining the expired snapshot with an unexpired snapshot and updating the metadata of the snapshot chain).

In some examples, at 335, the first backup service 220-a may send a command to the second backup service 225-a to perform one or more third tasks associated with a restore operation for the computing object 205-a. The second quantity of computing resources of the second set of cloud computing resources may be dynamic based on the one or more third tasks (e.g., based on the load of the one or more third tasks). At 340, the second backup service 225-a may perform the one or more third tasks. For example, the second backup service may retrieve a snapshot from the storage environment 240-a, decompress and/or decrypt the backup information from the snapshot, and restore the computing object 205-a using the retrieved and backup information. At 345, the second backup service 225-a may send, and the first backup service 220-a may receive, an indication of completion of the one or more third tasks. At 350, the first backup service 220-a may perform one or more fourth tasks associated with the restore operation. For example, the one or more fourth tasks may include identifying one or more storage locations at the storage environment 240-a of backup information corresponding to a restore time for the computing object 205-a based at least in part on a snapshot chain. The command at 335 may indicate the one or more storage locations at the storage environment 240-a, which the second backup service 225-a may use to retrieve the backup information. In some examples, the one or more fourth tasks may include updating the snapshot chain for the computing object 205-a based on restoring the backup information to the computing object 205-a. In some examples, the first backup service 220-a may obtain, from a user interface associated with the DMS 110-a, a request to restore the computing object 205-a to a version corresponding to a restore time, and the restore operation may be on the request.

In some examples, the DMS 110-a may manage backup and restore operations for multiple computing objects. For example, the first backup service 220-a may send a second command to the second backup service 225-a to perform one or more third tasks associated with a second backup operation for a second computing object, the second quantity of computing resources of the second set of cloud computing resources may be dynamic based on the one or more third tasks, and the one or more third tasks may overlap in time with the one or more first tasks. In some such examples, the second backup service 225-a may perform the one or more third tasks and send an indication of completion of the one or more third tasks to the first backup service 220-a. The first backup service 220-a may perform, based on the indication of the completion of the one or more third tasks, one or more fourth tasks associated with the second backup operation. In some examples, the first backup service 220-a may schedule the one or more second tasks and the one or more fourth tasks based on the first quantity of computing resources (e.g., to maintain a consistent load on the first quantity of computing resources).

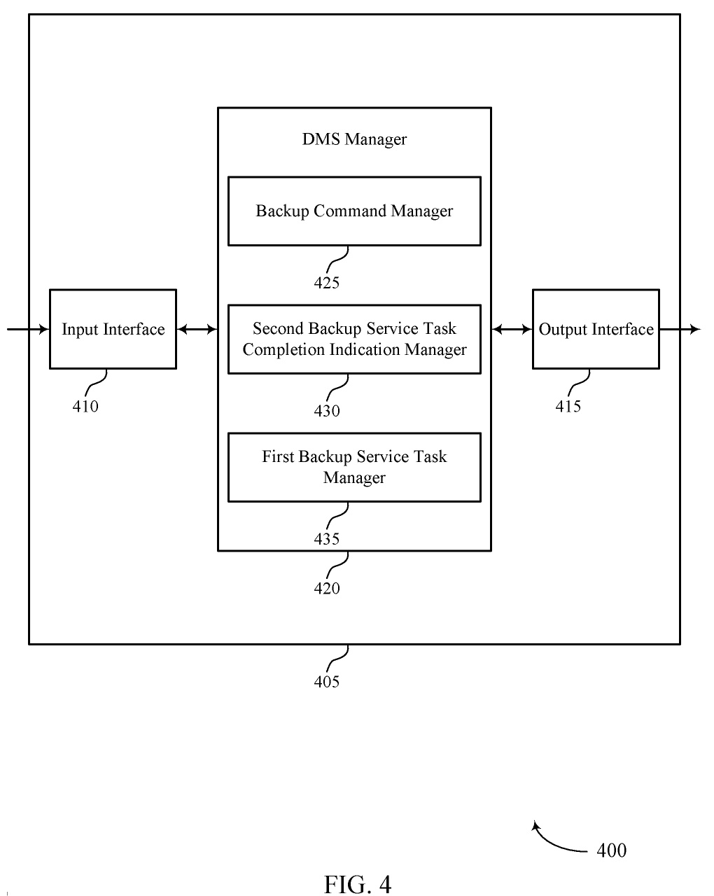

FIG. 4 shows a block diagram 400 of a system 405 that supports data management services using dynamic and static cloud computing resources in accordance with aspects of the present disclosure. In some examples, the system 405 may be an example of aspects of one or more components described with reference to FIG. 1, such as a DMS 110. The system 405 may include an input interface 410, an output interface 415, and a DMS Manager 420. The system 405 may also include one or more processors. Each of these components may be in communication with one another (e.g., via one or more buses, communications links, communications interfaces, or any combination thereof).

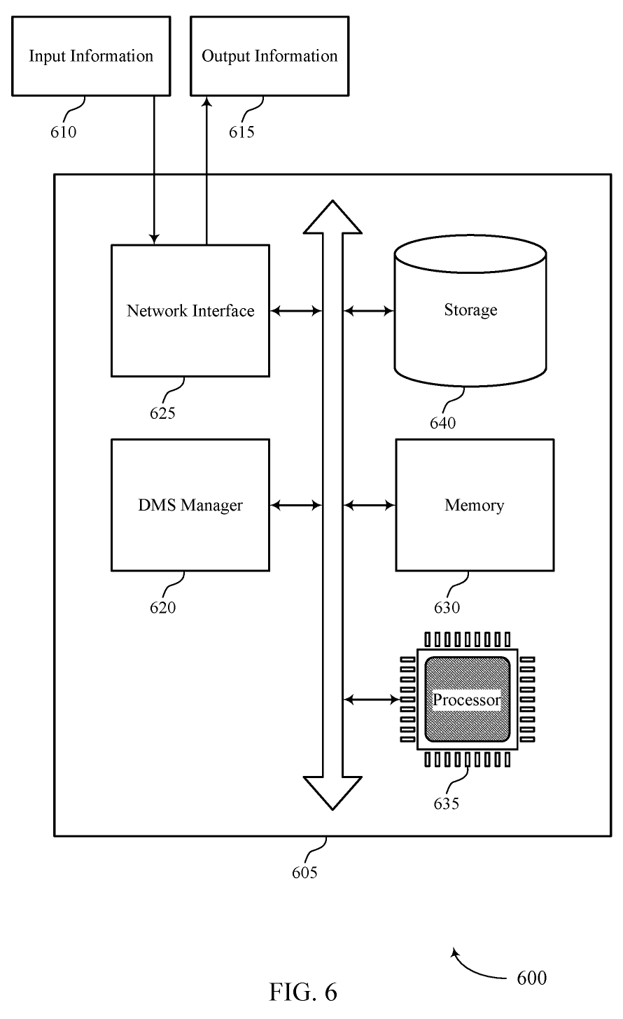

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the DMS Manager 420 to support data management services using dynamic and static cloud computing resources. In some cases, the input interface 410 may be a component of a network interface 625 as described with reference to FIG. 6.

The output interface 415 may manage output signaling for the system 405. For example, the output interface 415 may receive signaling from other components of the system 405, such as the DMS Manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the DMS Manager 420 may include a backup command manager 425, a second backup service task completion indication manager 430, a first backup service task manager 435, or any combination thereof. In some examples, the DMS Manager 420, or various components thereof, may be configured to perform various operations (e.g., receiving, monitoring, transmitting) using or otherwise in cooperation with the input interface 410, the output interface 415, or both. For example, the DMS Manager 420 may receive information from the input interface 410, send information to the output interface 415, or be integrated in combination with the input interface 410, the output interface 415, or both to receive information, transmit information, or perform various other operations as described herein.

The backup command manager 425 may be configured as or otherwise support a means for sending, by a first backup service of a DMS, a command to a second backup service of the DMS to perform one or more first tasks associated with a backup operation for a computing object, where the first backup service is hosted at a first set of cloud computing resources, where a first quantity of computing resources of the first set of cloud computing resources is static, where the second backup service is hosted at a second set of cloud computing resources, and where a second quantity of computing resources of the second set of cloud computing resources is dynamic based on the one or more first tasks. The second backup service task completion indication manager 430 may be configured as or otherwise support a means for receiving, by the first backup service, an indication of completion of the one or more first tasks. The first backup service task manager 435 may be configured as or otherwise support a means for performing, by the first backup service and based on the indication of the completion of the one or more first tasks, one or more second tasks associated with the backup operation.

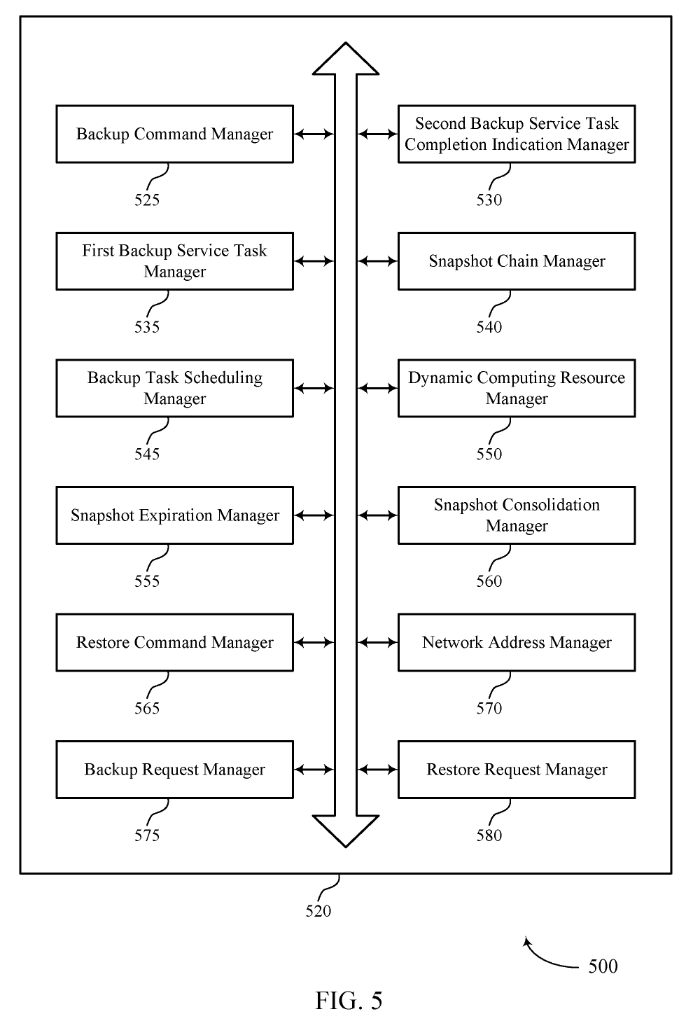

FIG. 5 shows a block diagram 500 of a DMS manager 520 that supports data management services using dynamic and static cloud computing resources in accordance with aspects of the present disclosure. The DMS manager 520 may be an example of aspects of a DMS manager 190 or a DMS Manager 420, or both, as described herein. The DMS manager 520, or various components thereof, may be an example of means for performing various aspects of data management services using dynamic and static cloud computing resources as described herein. For example, the DMS manager 520 may include a backup command manager 525, a second backup service task completion indication manager 530, a first backup service task manager 535, a snapshot chain manager 540, a backup task scheduling manager 545, a dynamic computing resource manager 550, a snapshot expiration manager 555, a snapshot consolidation manager 560, a restore command manager 565, a network address manager 570, a backup request manager 575, a restore request manager 580, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The backup command manager 525 may be configured as or otherwise support a means for sending, by a first backup service of a DMS, a command to a second backup service of the DMS to perform one or more first tasks associated with a backup operation for a computing object, where the first backup service is hosted at a first set of cloud computing resources, where a first quantity of computing resources of the first set of cloud computing resources is static, where the second backup service is hosted at a second set of cloud computing resources, and where a second quantity of computing resources of the second set of cloud computing resources is dynamic based on the one or more first tasks. The second backup service task completion indication manager 530 may be configured as or otherwise support a means for receiving, by the first backup service, an indication of completion of the one or more first tasks. The first backup service task manager 535 may be configured as or otherwise support a means for performing, by the first backup service and based on the indication of the completion of the one or more first tasks, one or more second tasks associated with the backup operation.

In some examples, to support performing the one or more first tasks, the snapshot chain manager 540 may be configured as or otherwise support a means for updating metadata associated with a snapshot chain for the computing object based on a storage location of a snapshot of the computing object associated with the backup operation, where the indication of completion of the one or more first tasks indicates the storage location of a snapshot of the computing object.

In some examples, the snapshot is an incremental snapshot. In some examples, updating the snapshot chain includes updating pointers to one or more prior snapshots of the computing object.

In some examples, the backup task scheduling manager 545 may be configured as or otherwise support a means for scheduling, by the first backup service, the one or more second tasks based on a load on the first set of cloud computing resources.

In some examples, the one or more first tasks include ingestion of backup information associated with the computing object, compression of the backup information, storage of the backup information at a storage environment, or a combination thereof.

In some examples, the dynamic computing resource manager 550 may be configured as or otherwise support a means for dynamically increasing the second quantity of computing resources of the second set of cloud computing resources based on an increase in an instantaneous load at the second backup service. In some examples, the dynamic computing resource manager 550 may be configured as or otherwise support a means for dynamically decreasing the second quantity of computing resources of the second set of cloud computing resources based on a decrease in the instantaneous load at the second backup service.

In some examples, the snapshot expiration manager 555 may be configured as or otherwise support a means for determining, by the first backup service, an expiration of a first snapshot of the computing object. In some examples, the snapshot consolidation manager 560 may be configured as or otherwise support a means for performing, by the first backup service or the second backup service and based on the expiration, a consolidation operation of the first snapshot with a second snapshot of the computing object.

In some examples, the snapshot consolidation manager 560 may be configured as or otherwise support a means for scheduling the consolidation operation based on a load on the first set of cloud computing resources or the second set of cloud computing resources.

In some examples, the restore command manager 565 may be configured as or otherwise support a means for sending, by the first backup service, a second command to the second backup service to perform one or more third tasks associated with a restore operation for the computing object, where the second quantity of computing resources of the second set of cloud computing resources is dynamic based on the one or more third tasks. In some examples, the second backup service task completion indication manager 530 may be configured as or otherwise support a means for receiving, by the first backup service, an indication of completion of the one or more third tasks. In some examples, the first backup service task manager 535 may be configured as or otherwise support a means for performing, by the first backup service, one or more fourth tasks associated with the restore operation.

In some examples, the one or more third tasks include retrieval of backup information corresponding to a restore time for the computing object from a storage environment.

In some examples, the one or more fourth tasks include identifying one or more storage locations at a storage environment of backup information corresponding to a restore time for the computing object based on a snapshot chain.

In some examples, the restore request manager 580 may be configured as or otherwise support a means for obtaining, by the first backup service from a user interface associated with the DMS, a request to restore the computing object to a version corresponding to a restore time, the restore operation based on the request.

In some examples, the network address manager 570 may be configured as or otherwise support a means for obtaining, by the first backup service, an indication of a second network address associated with the second backup service, where sending the command is based on the second network address, and where the command is indicative of a first network address associated with the first backup service.

In some examples, the backup request manager 575 may be configured as or otherwise support a means for obtaining, by the first backup service from a user interface associated with the DMS, a request to perform the backup operation for the computing object, where the backup operation is based on the request.

In some examples, the backup command manager 525 may be configured as or otherwise support a means for sending, by the first backup service, a second command to the second backup service to perform one or more third tasks associated with a second backup operation for a second computing object, and where the second quantity of computing resources of the second set of cloud computing resources is dynamic based on the one or more third tasks, and where the one or more third tasks overlap in time with the one or more first tasks. In some examples, the second backup service task completion indication manager 530 may be configured as or otherwise support a means for receiving, by the first backup service, an indication of completion of the one or more third tasks. In some examples, the first backup service task manager 535 may be configured as or otherwise support a means for performing, by the first backup service and based on the indication of the completion of the one or more third tasks, one or more fourth tasks associated with the second backup operation.

In some examples, the backup task scheduling manager 545 may be configured as or otherwise support a means for scheduling the one or more second tasks and the one or more fourth tasks based on the first quantity of computing resources.

FIG. 6 shows a block diagram 600 of a system 605 that supports data management services using dynamic and static cloud computing resources in accordance with aspects of the present disclosure. The system 605 may be an example of or include components of a system 405 as described herein. The system 605 may include components for data management, including components such as a DMS manager 620, an input information 610, an output information 615, a network interface 625, at least one memory 630, at least one processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting data management services using dynamic and static cloud computing resources). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

For example, the DMS manager 620 may be configured as or otherwise support a means for sending, by a first backup service of a DMS, a command to a second backup service of the DMS to perform one or more first tasks associated with a backup operation for a computing object, where the first backup service is hosted at a first set of cloud computing resources, where a first quantity of computing resources of the first set of cloud computing resources is static, where the second backup service is hosted at a second set of cloud computing resources, and where a second quantity of computing resources of the second set of cloud computing resources is dynamic based on the one or more first tasks. The DMS manager 620 may be configured as or otherwise support a means for receiving, by the first backup service, an indication of completion of the one or more first tasks. The DMS manager 620 may be configured as or otherwise support a means for performing, by the first backup service and based on the indication of the completion of the one or more first tasks, one or more second tasks associated with the backup operation.

By including or configuring the DMS manager 620 in accordance with examples as described herein, the system 605 may support techniques for data management services using dynamic and static cloud computing resources, which may provide one or more benefits such as, for example, improved reliability, reduced latency, reduced power consumption, more efficient utilization of computing resources, network resources or both, and/or improved scalability, among other possibilities.

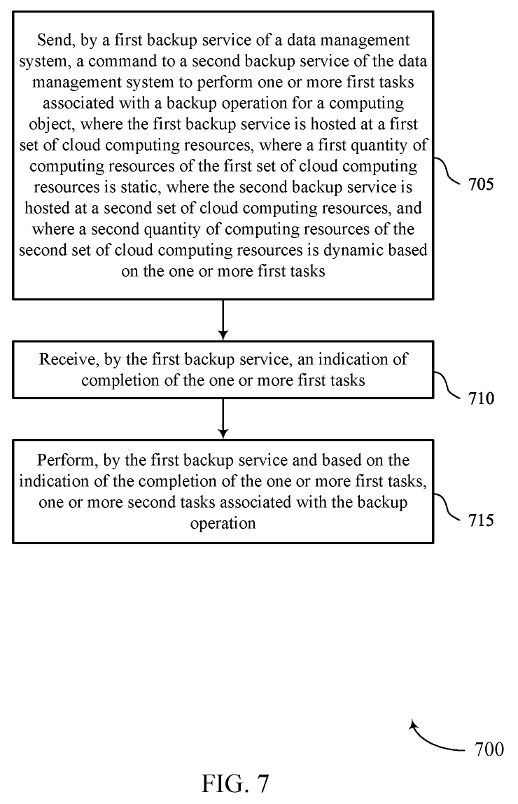

FIG. 7 shows a flowchart illustrating a method 700 that supports data management services using dynamic and static cloud computing resources in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include sending, by a first backup service of a DMS, a command to a second backup service of the DMS to perform one or more first tasks associated with a backup operation for a computing object, where the first backup service is hosted at a first set of cloud computing resources, where a first quantity of computing resources of the first set of cloud computing resources is static, where the second backup service is hosted at a second set of cloud computing resources, and where a second quantity of computing resources of the second set of cloud computing resources is dynamic based on the one or more first tasks. The operations of 705 may be performed in accordance with examples as disclosed herein. In some examples, aspects of the operations of 705 may be performed by a backup command manager 525 as described with reference to FIG. 5.

At 710, the method may include receiving, by the first backup service, an indication of completion of the one or more first tasks. The operations of 710 may be performed in accordance with examples as disclosed herein. In some examples, aspects of the operations of 710 may be performed by a second backup service task completion indication manager 530 as described with reference to FIG. 5.

At 715, the method may include performing, by the first backup service and based on the indication of the completion of the one or more first tasks, one or more second tasks associated with the backup operation. The operations of 715 may be performed in accordance with examples as disclosed herein. In some examples, aspects of the operations of 715 may be performed by a first backup service task manager 535 as described with reference to FIG. 5.

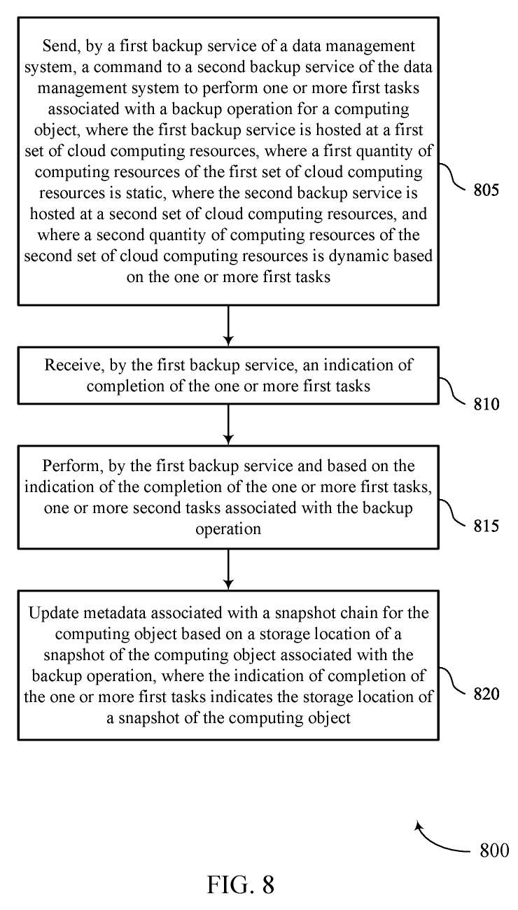

FIG. 8 shows a flowchart illustrating a method 800 that supports data management services using dynamic and static cloud computing resources in accordance with aspects of the present disclosure. The operations of the method 800 may be implemented by a DMS or its components as described herein. For example, the operations of the method 800 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 805, the method may include sending, by a first backup service of a DMS, a command to a second backup service of the DMS to perform one or more first tasks associated with a backup operation for a computing object, where the first backup service is hosted at a first set of cloud computing resources, where a first quantity of computing resources of the first set of cloud computing resources is static, where the second backup service is hosted at a second set of cloud computing resources, and where a second quantity of computing resources of the second set of cloud computing resources is dynamic based on the one or more first tasks. The operations of 805 may be performed in accordance with examples as disclosed herein. In some examples, aspects of the operations of 805 may be performed by a backup command manager 525 as described with reference to FIG. 5.

At 810, the method may include receiving, by the first backup service, an indication of completion of the one or more first tasks. The operations of 810 may be performed in accordance with examples as disclosed herein. In some examples, aspects of the operations of 810 may be performed by a second backup service task completion indication manager 530 as described with reference to FIG. 5.

At 815, the method may include performing, by the first backup service and based on the indication of the completion of the one or more first tasks, one or more second tasks associated with the backup operation. The operations of 815 may be performed in accordance with examples as disclosed herein. In some examples, aspects of the operations of 815 may be performed by a first backup service task manager 535 as described with reference to FIG. 5.

At 820, the method may include updating metadata associated with a snapshot chain for the computing object based on a storage location of a snapshot of the computing object associated with the backup operation, where the indication of completion of the one or more first tasks indicates the storage location of a snapshot of the computing object. The operations of 820 may be performed in accordance with examples as disclosed herein. In some examples, aspects of the operations of 820 may be performed by a snapshot chain manager 540 as described with reference to FIG. 5.

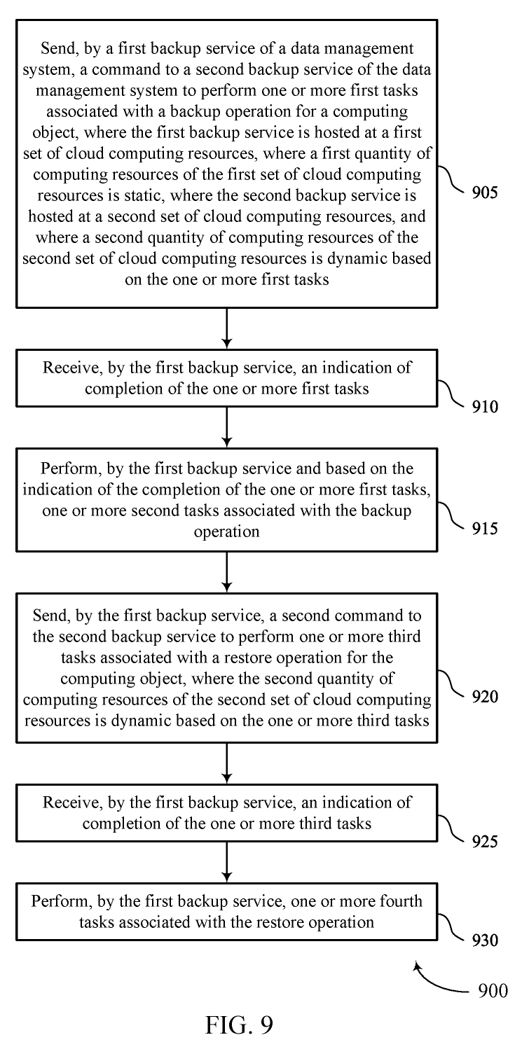

FIG. 9 shows a flowchart illustrating a method 900 that supports data management services using dynamic and static cloud computing resources in accordance with aspects of the present disclosure. The operations of the method 900 may be implemented by a DMS or its components as described herein. For example, the operations of the method 900 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 905, the method may include sending, by a first backup service of a DMS, a command to a second backup service of the DMS to perform one or more first tasks associated with a backup operation for a computing object, where the first backup service is hosted at a first set of cloud computing resources, where a first quantity of computing resources of the first set of cloud computing resources is static, where the second backup service is hosted at a second set of cloud computing resources, and where a second quantity of computing resources of the second set of cloud computing resources is dynamic based on the one or more first tasks. The operations of 905 may be performed in accordance with examples as disclosed herein. In some examples, aspects of the operations of 905 may be performed by a backup command manager 525 as described with reference to FIG. 5.

At 910, the method may include receiving, by the first backup service, an indication of completion of the one or more first tasks. The operations of 910 may be performed in accordance with examples as disclosed herein. In some examples, aspects of the operations of 910 may be performed by a second backup service task completion indication manager 530 as described with reference to FIG. 5.

At 915, the method may include performing, by the first backup service and based on the indication of the completion of the one or more first tasks, one or more second tasks associated with the backup operation. The operations of 915 may be performed in accordance with examples as disclosed herein. In some examples, aspects of the operations of 915 may be performed by a first backup service task manager 535 as described with reference to FIG. 5.

At 920, the method may include sending, by the first backup service, a second command to the second backup service to perform one or more third tasks associated with a restore operation for the computing object, where the second quantity of computing resources of the second set of cloud computing resources is dynamic based on the one or more third tasks. The operations of 920 may be performed in accordance with examples as disclosed herein. In some examples, aspects of the operations of 920 may be performed by a restore command manager 565 as described with reference to FIG. 5.

At 925, the method may include receiving, by the first backup service, an indication of completion of the one or more third tasks. The operations of 925 may be performed in accordance with examples as disclosed herein. In some examples, aspects of the operations of 925 may be performed by a second backup service task completion indication manager 530 as described with reference to FIG. 5.

At 930, the method may include performing, by the first backup service, one or more fourth tasks associated with the restore operation. The operations of 930 may be performed in accordance with examples as disclosed herein. In some examples, aspects of the operations of 930 may be performed by a first backup service task manager 535 as described with reference to FIG. 5.

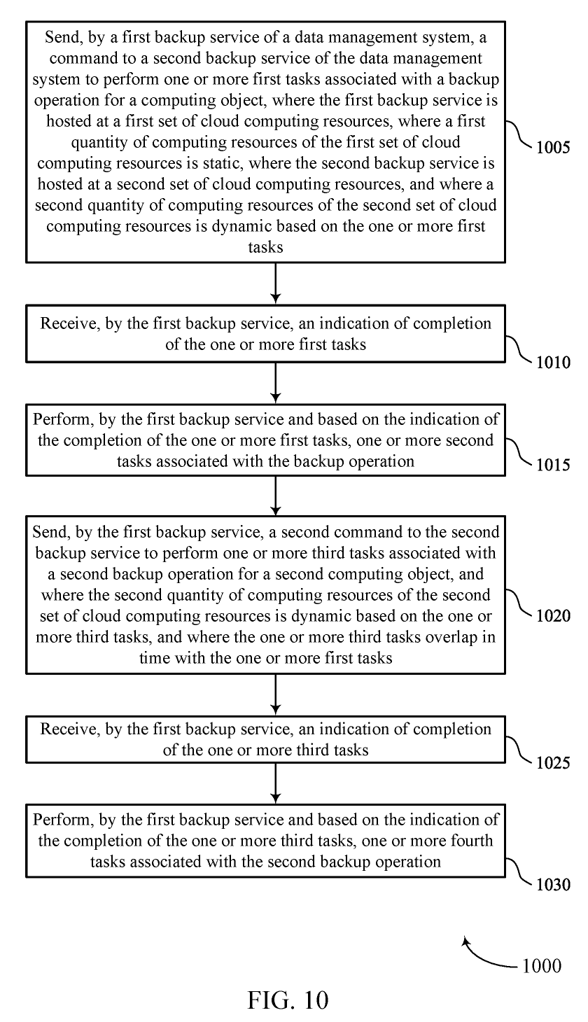

FIG. 10 shows a flowchart illustrating a method 1000 that supports data management services using dynamic and static cloud computing resources in accordance with aspects of the present disclosure. The operations of the method 1000 may be implemented by a DMS or its components as described herein. For example, the operations of the method 1000 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 1005, the method may include sending, by a first backup service of a DMS, a command to a second backup service of the DMS to perform one or more first tasks associated with a backup operation for a computing object, where the first backup service is hosted at a first set of cloud computing resources, where a first quantity of computing resources of the first set of cloud computing resources is static, where the second backup service is hosted at a second set of cloud computing resources, and where a second quantity of computing resources of the second set of cloud computing resources is dynamic based on the one or more first tasks. The operations of 1005 may be performed in accordance with examples as disclosed herein. In some examples, aspects of the operations of 1005 may be performed by a backup command manager 525 as described with reference to FIG. 5.

At 1010, the method may include receiving, by the first backup service, an indication of completion of the one or more first tasks. The operations of 1010 may be performed in accordance with examples as disclosed herein. In some examples, aspects of the operations of 1010 may be performed by a second backup service task completion indication manager 530 as described with reference to FIG. 5.

At 1015, the method may include performing, by the first backup service and based on the indication of the completion of the one or more first tasks, one or more second tasks associated with the backup operation. The operations of 1015 may be performed in accordance with examples as disclosed herein. In some examples, aspects of the operations of 1015 may be performed by a first backup service task manager 535 as described with reference to FIG. 5.

At 1020, the method may include sending, by the first backup service, a second command to the second backup service to perform one or more third tasks associated with a second backup operation for a second computing object, and where the second quantity of computing resources of the second set of cloud computing resources is dynamic based on the one or more third tasks, and where the one or more third tasks overlap in time with the one or more first tasks. The operations of 1020 may be performed in accordance with examples as disclosed herein. In some examples, aspects of the operations of 1020 may be performed by a backup command manager 525 as described with reference to FIG. 5.

At 1025, the method may include receiving, by the first backup service, an indication of completion of the one or more third tasks. The operations of 1025 may be performed in accordance with examples as disclosed herein. In some examples, aspects of the operations of 1025 may be performed by a second backup service task completion indication manager 530 as described with reference to FIG. 5.

At 1030, the method may include performing, by the first backup service and based on the indication of the completion of the one or more third tasks, one or more fourth tasks associated with the second backup operation. The operations of 1030 may be performed in accordance with examples as disclosed herein. In some examples, aspects of the operations of 1030 may be performed by a first backup service task manager 535 as described with reference to FIG. 5.

### The following provides an overview of aspects of the present disclosure:

Aspect 1: A method, comprising: sending, by a first backup service of a DMS, a command to a second backup service of the DMS to perform one or more first tasks associated with a backup operation for a computing object, wherein the first backup service is hosted at a first set of cloud computing resources, wherein a first quantity of computing resources of the first set of cloud computing resources is static, wherein the second backup service is hosted at a second set of cloud computing resources, and wherein a second quantity of computing resources of the second set of cloud computing resources is dynamic based at least in part on the one or more first tasks; receiving, by the first backup service, an indication of completion of the one or more first tasks; and performing, by the first backup service and based at least in part on the indication of the completion of the one or more first tasks, one or more second tasks associated with the backup operation.

Aspect 2: The method of aspect 1, wherein performing the one or more first tasks comprises: updating metadata associated with a snapshot chain for the computing object based at least in part on a storage location of a snapshot of the computing object associated with the backup operation, wherein the indication of completion of the one or more first tasks indicates the storage location of a snapshot of the computing object.

Aspect 3: The method of aspect 2, wherein the snapshot is an incremental snapshot, and updating the snapshot chain comprises updating pointers to one or more prior snapshots of the computing object.

Aspect 4: The method of any of aspects 1 through 3, further comprising: scheduling, by the first backup service, the one or more first tasks based at least in part on a load on the first set of cloud computing resources.

Aspect 5: The method of any of aspects 1 through 4, wherein the one or more first tasks comprise ingestion of backup information associated with the computing object, compression of the backup information, storage of the backup information at a storage environment, or a combination thereof.

Aspect 6: The method of any of aspects 1 through 5, further comprising: dynamically increasing the second quantity of computing resources of the second set of cloud computing resources based on an increase in an instantaneous load at the second backup service; and dynamically decreasing the second quantity of computing resources of the second set of cloud computing resources based on a decrease in the instantaneous load at the second backup service.

Aspect 7: The method of any of aspects 1 through 6, further comprising: determining, by the first backup service, an expiration of a first snapshot of the computing object; and performing, by the first backup service or the second backup service and based at least in part on the expiration, a consolidation operation of the first snapshot with a second snapshot of the computing object.

Aspect 8: The method of aspect 7, further comprising: scheduling the consolidation operation based at least in part on a load on the first set of cloud computing resources or the second set of cloud computing resources.

Aspect 9: The method of any of aspects 1 through 8, further comprising: sending, by the first backup service, a second command to the second backup service to perform one or more third tasks associated with a restore operation for the computing object, wherein the second quantity of computing resources of the second set of cloud computing resources is dynamic based at least in part on the one or more third tasks; receiving, by the first backup service, an indication of completion of the one or more third tasks; and performing, by the first backup service, one or more fourth tasks associated with the restore operation.

Aspect 10: The method of aspect 9, wherein the one or more third tasks comprise retrieval of backup information corresponding to a restore time for the computing object from a storage environment.

Aspect 11: The method of any of aspects 9 through 10, wherein the one or more fourth tasks comprise identifying one or more storage locations at a storage environment of backup information corresponding to a restore time for the computing object based at least in part on a snapshot chain.

Aspect 12: The method of any of aspects 9 through 11, further comprising: obtaining, by the first backup service from a user interface associated with the DMS, a request to restore the computing object to a version corresponding to a restore time, the restore operation based at least in part on the request.

Aspect 13: The method of any of aspects 1 through 12, further comprising: obtaining, by the first backup service, an indication of a second network address associated with the second backup service, wherein sending the command is based at least in part on the second network address, and wherein the command is indicative of a first network address associated with the first backup service.

Aspect 14: The method of any of aspects 1 through 13, further comprising: obtaining, by the first backup service from a user interface associated with the DMS, a request to perform the backup operation for the computing object, wherein the backup operation is based at least in part on the request.

Aspect 15: The method of any of aspects 1 through 14, further comprising: sending, by the first backup service, a second command to the second backup service to perform one or more third tasks associated with a second backup operation for a second computing object, and wherein the second quantity of computing resources of the second set of cloud computing resources is dynamic based at least in part on the one or more third tasks, and wherein the one or more third tasks overlap in time with the one or more first tasks; receiving, by the first backup service, an indication of completion of the one or more third tasks; and performing, by the first backup service and based at least in part on the indication of the completion of the one or more third tasks, one or more fourth tasks associated with the second backup operation.

Aspect 16: The method of aspect 15, further comprising: scheduling the one or more second tasks and the one or more fourth tasks based at least in part on the first quantity of computing resources.

Aspect 17: An apparatus comprising one or more memories storing processor-executable code, and one or more processors coupled with the one or more memories and individually or collectively operable to execute the code to cause the apparatus to perform a method of any of aspects 1 through 16.

Aspect 18: An apparatus comprising at least one means for performing a method of any of aspects 1 through 16.

Aspect 19: A non-transitory computer-readable medium storing code the code comprising instructions executable by one or more processors to perform a method of any of aspects 1 through 16.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
sending, by a first backup service of a data management system, a command to a second backup service of the data management system to perform one or more first tasks associated with a backup operation for a computing object, wherein the first backup service is hosted at a first set of cloud computing resources, wherein a first quantity of computing resources of the first set of cloud computing resources is static, wherein the second backup service is hosted at a second set of cloud computing resources, and wherein a second quantity of computing resources of the second set of cloud computing resources is dynamic based at least in part on the one or more first tasks;
receiving, by the first backup service, an indication of completion of the one or more first tasks; and
performing, by the first backup service and based at least in part on the indication of the completion of the one or more first tasks, one or more second tasks associated with the backup operation.

2. The method of claim 1, wherein performing the one or more first tasks comprises:
updating metadata associated with a snapshot chain for the computing object based at least in part on a storage location of a snapshot of the computing object associated with the backup operation, wherein the indication of completion of the one or more first tasks indicates the storage location of a snapshot of the computing object.

3. The method of claim 2, wherein:
the snapshot is an incremental snapshot, and
updating the snapshot chain comprises updating pointers to one or more prior snapshots of the computing object.

4. The method of claim 1, further comprising:
scheduling, by the first backup service, the one or more second tasks based at least in part on a load on the first set of cloud computing resources.

5. The method of claim 1, wherein the one or more first tasks comprise ingestion of backup information associated with the computing object, compression of the backup information, storage of the backup information at a storage environment, or a combination thereof.

6. The method of claim 1, further comprising:
dynamically increasing the second quantity of computing resources of the second set of cloud computing resources based on an increase in an instantaneous load at the second backup service; and
dynamically decreasing the second quantity of computing resources of the second set of cloud computing resources based on a decrease in the instantaneous load at the second backup service.

7. The method of claim 1, further comprising:
determining, by the first backup service, an expiration of a first snapshot of the computing object; and
performing, by the first backup service or the second backup service and based at least in part on the expiration, a consolidation operation of the first snapshot with a second snapshot of the computing object.

8. The method of claim 7, further comprising:
scheduling the consolidation operation based at least in part on a load on the first set of cloud computing resources or the second set of cloud computing resources.

9. The method of claim 1, further comprising:
sending, by the first backup service, a second command to the second backup service to perform one or more third tasks associated with a restore operation for the computing object, wherein the second quantity of computing resources of the second set of cloud computing resources is dynamic based at least in part on the one or more third tasks;
receiving, by the first backup service, an indication of completion of the one or more third tasks; and
performing, by the first backup service, one or more fourth tasks associated with the restore operation.

10. The method of claim 9, wherein the one or more third tasks comprise retrieval of backup information corresponding to a restore time for the computing object from a storage environment.

11. The method of claim 9, wherein the one or more fourth tasks comprise identifying one or more storage locations at a storage environment of backup information corresponding to a restore time for the computing object based at least in part on a snapshot chain.

12. The method of claim 9, further comprising:
obtaining, by the first backup service from a user interface associated with the data management system, a request to restore the computing object to a version corresponding to a restore time, the restore operation based at least in part on the request.

13. The method of claim 1, further comprising:
obtaining, by the first backup service, an indication of a second network address associated with the second backup service, wherein sending the command is based at least in part on the second network address, and wherein the command is indicative of a first network address associated with the first backup service.

14. The method of claim 1, further comprising:
obtaining, by the first backup service from a user interface associated with the data management system, a request to perform the backup operation for the computing object, wherein the backup operation is based at least in part on the request.

15. The method of claim 1, further comprising:
sending, by the first backup service, a second command to the second backup service to perform one or more third tasks associated with a second backup operation for a second computing object, and wherein the second quantity of computing resources of the second set of cloud computing resources is dynamic based at least in part on the one or more third tasks, and wherein the one or more third tasks overlap in time with the one or more first tasks;
receiving, by the first backup service, an indication of completion of the one or more third tasks; and
performing, by the first backup service and based at least in part on the indication of the completion of the one or more third tasks, one or more fourth tasks associated with the second backup operation.

16. The method of claim 15, further comprising:
scheduling the one or more second tasks and the one or more fourth tasks based at least in part on the first quantity of computing resources.

17. An apparatus, comprising:
one or more memories storing processor-executable code; and
one or more processors coupled with the one or more memories and individually or collectively operable to execute the code to cause the apparatus to:
send, by a first backup service of a data management system, a command to a second backup service of the data management system to perform one or more first tasks associated with a backup operation for a computing object, wherein the first backup service is hosted at a first set of cloud computing resources, wherein a first quantity of computing resources of the first set of cloud computing resources is static, wherein the second backup service is hosted at a second set of cloud computing resources, and wherein a second quantity of computing resources of the second set of cloud computing resources is dynamic based at least in part on the one or more first tasks;
receive, by the first backup service, an indication of completion of the one or more first tasks; and
perform, by the first backup service and based at least in part on the indication of the completion of the one or more first tasks, one or more second tasks associated with the backup operation.

18. The apparatus of claim 17, wherein, to perform the one or more first tasks, the one or more processors are individually or collectively operable to execute the code to cause the apparatus to:
update metadata associated with a snapshot chain for the computing object based at least in part on a storage location of a snapshot of the computing object associated with the backup operation, wherein the indication of completion of the one or more first tasks indicates the storage location of a snapshot of the computing object.

19. The apparatus of claim 18, wherein:
the snapshot is an incremental snapshot, and
updating the snapshot chain comprises updating pointers to one or more prior snapshots of the computing object.

20. A non-transitory computer-readable medium storing code, the code comprising instructions executable by one or more processors to:
send, by a first backup service of a data management system, a command to a second backup service of the data management system to perform one or more first tasks associated with a backup operation for a computing object, wherein the first backup service is hosted at a first set of cloud computing resources, wherein a first quantity of computing resources of the first set of cloud computing resources is static, wherein the second backup service is hosted at a second set of cloud computing resources, and wherein a second quantity of computing resources of the second set of cloud computing resources is dynamic based at least in part on the one or more first tasks;
receive, by the first backup service, an indication of completion of the one or more first tasks; and
perform, by the first backup service and based at least in part on the indication of the completion of the one or more first tasks, one or more second tasks associated with the backup operation.
